(19) United States
(12) Patent Application Publication
(10) Pub. No.: US 2008/0019128 A1
(43) Pub. Date: Jan. 24, 2008

(54) LED lamp

(75) Inventor: Sing Chu, Taipei City (TW)

Correspondence Address: BACON & THOMAS, PLLC, 625 SLATERS LANE, FOURTH FLOOR, ALEXANDRIA, VA, 22314, US

(73) Assignee: DJ Auto Components Corp., Kui-Hsan Hsiang (TW)

(21) Appl. No.: 11/649,768

(22) Filed: Jan. 5, 2007

(30) Foreign Application Priority Data
Jul. 19, 2006 (TW) 095212622

(51) Int. Cl. F21V 11/00

(52) U.S. Cl. 362/240

(57) ABSTRACT

A LED lamp having a housing with two locating members on the inside, a circuit board mounted on the locating members and kept spaced above the bottom wall of the housing at a distance, LEDs installed in the circuit board, and a lens, which is covered on the housing over the circuit board and the LEDs and has accommodation holes in the inside wall thereof for accommodating the LEDs respectively such that the lens and the housing keep the circuit board from sight and, the lens allows the light of the LEDs to pass to the outside through the thin wall thickness area of the inside wall corresponding to the accommodation holes.

### BACKGROUND OF THE INVENTION

1. Field of the Invention

The present invention relates to a LED lamp and more particularly, to a directional LED lamp for motor vehicle.

2. Description of Related Art

For the sack of safety driving, a car generally has directional lamps mounted on the two opposite lateral sides of the car body in addition to the locations at the front and rear sides of the car body, so that the directional lamp on one lateral side of the car body gives a warning signal to the drivers of the cars running behind or the persons walking nearby.

Following the popularity of the application of LED (light Emitting Diode), LED lamps have been intensively used in motor vehicles for the advantages of power saving, quick reaction speed, small size, and long service life. In addition to the purpose of illumination, LED lamps have been intensively used as directional lights for motor vehicle to substitute for conventional lamp bulbs.

A regular LED lamp generally comprises a lens, a bezel, a circuit board, and a housing respectively arranged in proper order from the outside toward the inside. The outer lens has a smoothly curved profile fitting the streamline configuration of the car body, or showing an active design. The bezel separates the circuit board from the lens, reflects the light of the LED(s), and decorates the circuit board.

A conventional LED lamp needs a bezel to reflect the light of the LED(s) and to keep the circuit board from sight, so as to enhance the nice outer looking of the whole assembly of the lamp. However, the use of a bezel in a LED lamp greatly complicates the structure of the lamp.

Therefore, it is desirable to provide a LED lamp that eliminates the aforesaid drawback.

### SUMMARY OF THE INVENTION

The present invention has been accomplished under the circumstances in view. According to one embodiment of the present invention, the LED lamp comprises a housing, a circuit board, at least one light emitting diode, and a lens.

The housing comprises at least one locating member. The circuit board is mounted on the at least one locating member inside the housing. The at least one light emitting diode is respectively fixedly mounted on and electrically connected to the circuit board. The lens is fastened to the housing and covered over the circuit board and the at least one light emitting diode, having an inside wall and at least one accommodation hole formed in the inside wall for accommodating the at least one light emitting diode respectively. The lens and the housing keep the circuit board from sight, however, the lens allows the light of the at least one light emitting diode to pass to the outside through the thin wall thickness area of the inside wall corresponding to the accommodation holes. Because the invention eliminates the use of a bezel, the LED lamp can easily be assembled.

Further, each accommodation hole of the lens can be a round hole. The round hole can be stepped, or tilted to guide the direction of emission of the light from the associating light emitting diode. Further, the peripheral wall of each accommodation hole can be constructed to have different heights at different sides, or to have an equal height at all sides.

Further, the at least one locating member of the housing is comprised of two locating rods symmetrically disposed near two distal ends thereof, and the circuit board has two mounting through holes respectively coupled to the locating rods of the at least one locating member. The locating rods of the at least one locating member of the housing can be round rods, stepped rods, conical rods, or rod members of any of a variety of shapes that support the circuit board firmly in place and kept the circuit board spaced above the bottom wall of the housing at a distance.

Further, the at least one locating member can be formed integral with the housing to save the cost.

Further, the lens is integrally molded from plastics, having a corrugated or embossed outer surface that reinforces the structural strength of the lens.

Further, the lens can be fastened to the housing by means of any of a variety of joints, for example, a flanged joint, or with any of a variety of fastening devices, for example, screws.

Further, the least one light emitting diode is relatively selected from at least one of the groups of red light emitting diodes, green light emitting diodes, blue light emitting diodes, yellow light emitting diodes and white light emitting diodes.

Further, the LED lamp of the invention can be used in a car as a side directional light or small light, or in a house as a small night light, or in any different places for different purposes.

### BRIEF DESCRIPTION OF THE DRAWINGS

FIG. 1 is an exploded view of a LED lamp according to the present invention.

FIG. 2 is a sectional assembly view of the LED lamp according to the present invention.

FIG. 3 is an applied view showing the LED lamp installed in a car and used as a directional lamp according to the present invention.

FIG. 4 is another applied view of the present invention showing the LED lamp used with an electric plug as a small night light.

### DETAILED DESCRIPTION OF THE PREFERRED EMBODIMENT

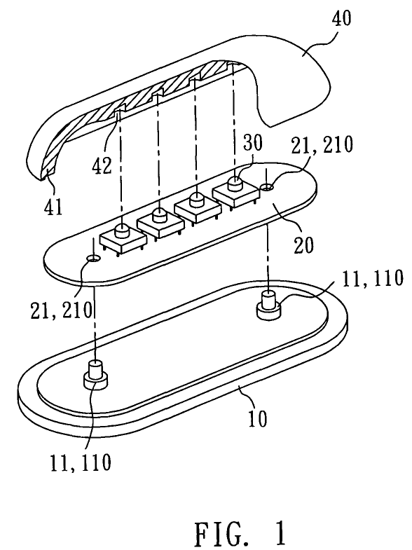

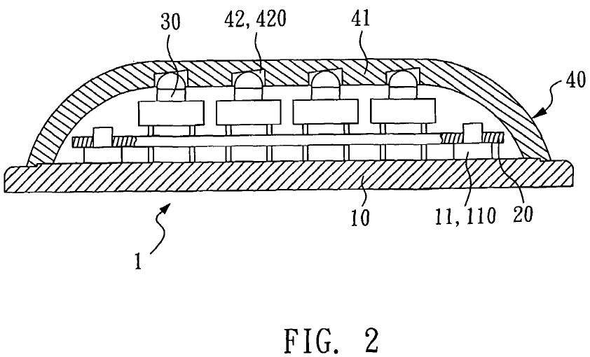

Referring to FIGS. 1 and 2, a LED lamp 1 in accordance with the present invention is shown comprised of a housing 10, a circuit board 20, four LEDs (Light Emitting Diodes) 30, and a lens 40.

As shown in FIG. 1, the housing 10 has two locating members 11 symmetrically arranged near two distal ends thereof for supporting the circuit board 20 firmly in a balanced manner. The circuit board 20 has two mounting through holes 21 corresponding to the locating members 11 of the housing 10. During installation, the two mounting through holes 21 of the circuit board 20 are respectively coupled to the locating members 11 of the housing 10.

In this embodiment, the locating members 11 of the housing 10 are stepped round rods 110 such that the circuit board 20 is supported on a step at each stepped round rod 110 and kept spaced above the bottom wall of the housing 10 at a distance when the two mounting through holes 21 of the circuit board 20 are respectively coupled to the locating members 11 of the housing 10. Preferably, the two stepped round rods 110 are formed integral with the housing 10 to reduce the number of parts of the LED lamp 1.

Further, as shown in FIG. 2, the four LEDs 30 can be red LEDs, green LEDs, blue LEDs, yellow LEDs, white LEDs, and/or their combination, and are fixedly mounted on and electrically connected to the circuit board 20. The lens 40 is fastened to the housing 10 over the circuit board 20 by means of, for example, a flanged joint, having an inside wall 41 of a predetermined thickness and four accommodation holes 42 on the inside wall 41 for accommodating the LEDs 30 respectively. According to this embodiment, the accommodation holes 42 are round holes 420, and the lens 40 is directly molded from plastics in integrity.

When assembled, the LEDs 30 are respectively accommodated in the four round holes 420, and the periphery of each LED 30 is kept spaced from the inside wall 41 of the lens 40 at about 0.5 mm. Thus, the housing 10 and the lens 40 keep the circuit board 20 from sight, and the lens 40 allows the light of the LEDs 30 to pass to the outside through the thin wall thickness area of the inside wall 41 corresponding to the round holes 420. Because the invention eliminates the use of a bezel, the LED lamp 1 can easily be assembled.

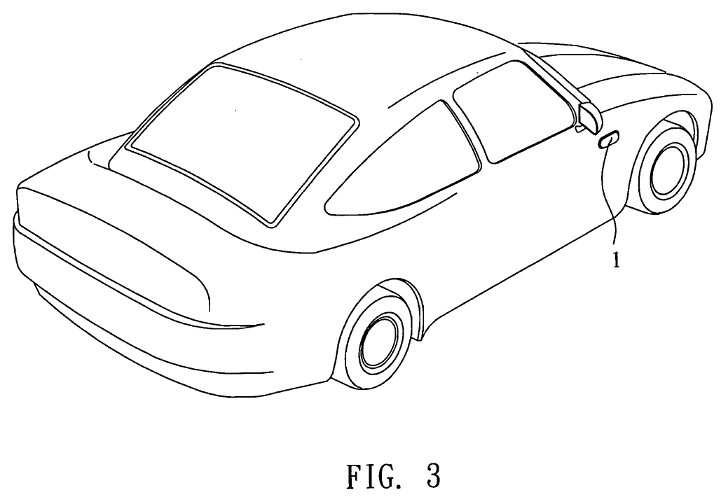

Referring to FIG. 3, the LED lamp 1 can be mounted on a car at one lateral side for use as a directional light.

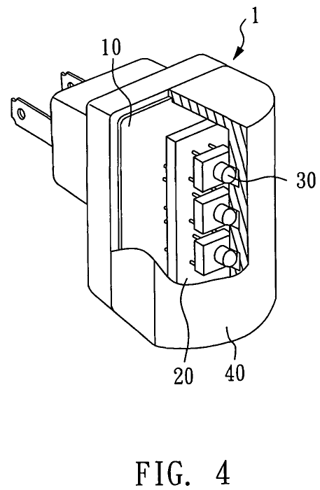

Referring to FIG. 4, the LED lamp 1 can be used or mounted with an electric plug to form a small night light.

Although the present invention has been explained in relation to its preferred embodiment, it is to be understood that many other possible modifications and variations can be made without departing from the spirit and scope of the invention as hereinafter claimed.

What is claimed is:

1. A LED lamp comprising:
a housing, said housing comprising at least one locating member;
a circuit board mounted on said at least one locating member inside said housing;
at least one light emitting diode fixedly mounted on and electrically connected to said circuit board; and
a lens fastened to said housing and covered over said circuit board and said at least one light emitting diode, said lens having an inside wall and at least one accommodation hole formed in said inside wall for accommodating said at least one light emitting diode respectively.

2. The LED lamp as claimed in claim 1, wherein said at least one accommodation hole each is a round hole.

3. The LED lamp as claimed in claim 1, wherein the at least one locating member of said housing is comprised of two locating rods symmetrically disposed near two distal ends thereof.

4. The LED lamp as claimed in claim 3, wherein said circuit board has two mounting through holes respectively coupled to the locating rods of said at least one locating member.

5. The LED lamp as claimed in claim 4, wherein the locating rods of the at least one locating member of said housing are round rods; the mounting through holes of said circuit board are round holes fitting the round rods of the at least one locating member of said housing.

6. The LED lamp as claimed in claim 5, wherein the round rods of the at least one locating member of said housing are stepped round rods.

7. The LED lamp as claimed in claim 1, wherein said at least one locating member is formed integral with said housing.

8. The LED lamp as claimed in claim 1, wherein said lens is integrally molded from plastics.

9. The LED lamp as claimed in claim 1, wherein said lens is fastened to said housing by means of a flanged joint.

10. The LED lamp as claimed in claim 1, wherein said at least one light emitting diode is relatively selected from at least one of the groups of red light emitting diodes, green light emitting diodes, blue light emitting diodes, yellow light emitting diodes and white light emitting diodes.
